(19) United States
(12) Patent Application Publication
(10) Pub. No.: US 2016/0275415 A1
(43) Pub. Date: Sep. 22, 2016

(54) READER LEARNING METHOD AND DEVICE, DATA RECOGNITION METHOD AND DEVICE

(71) Applicant: SAMSUNG ELECTRONICS CO., LTD., Suwon-si (KR)

(72) Inventors: Byungin YOO, Suwon-si (KR); Wonjun KIM, Suwon-si (KR); Chang Kyu CHOI, Suwon-si (KR); Jaejoon HAN, Suwon-si (KR)

(73) Assignee: SAMSUNG ELECTRONICS CO., LTD., Suwon-si (KR)

(21) Appl. No.: 15/030,520

(22) PCT Filed: Nov. 11, 2014
(86) PCT No.: PCT/KR2014/010789

§ 371 Date: Apr. 19, 2016

(30) Foreign Application Priority Data
Nov. 11, 2013 (KR) 10-2013-0136474

(51) Int. Cl. G06N 99/00; G06N 5/04; G06F 17/30

(52) U.S. Cl. CPC G06N 99/005; G06F 17/30598; G06N 5/048

(57) ABSTRACT

A recognizer training method and apparatus includes selecting training data, generating clusters by clustering the selected training data based on a global shape parameter, and classifying training data from at least one cluster based on a local shape feature.

### CROSS -REFERENCE TO RELATED APPLICATION(S)

This application is a U.S. national stage application of International Application No. PCT/KR2014/010789 filed on Nov. 11, 2014, which claims the benefit of Korean Patent Application No. 1 0-201 3-01 36474 filed on Nov. 11, 2013, in the Korean Intellectual Property Office, the entire disclosures of which are incorporated herein by reference for all purposes.

### BACKGROUND

1. Field

The following description relate to a reader learning and recognition device and method.

2. Background Art

Recently, an importance of machine learning has increased in various image processing fields. A technology for detecting a target from an input image is applicable to a computer vision application system. In general, the technology for detecting the target from the input image may include setting sub-windows in various sizes and positions and expressing a feature extracted from a sub-window with a feature vector. The feature vector may be applied to a training classifier to detect whether an area of the sub-window corresponds to the target.

A simply structured classifier may obtain a distance between vectors, for example, a Euclidian distance, or similarity, for example, normalized correlation, and classify the target and a non-target by comparing the distance between the vectors or the similarity to thresholds. A more elaborate classifier may include a nerve network, a Bayesian classifier, a support vector machine (SVM) learning classifier, and an Adaptive Boosting (Adaboost) learning classifier.

The Adaboost learning classifier may form a strong classifier having a desirable classifying ability by combining a weak classifier fast in calculation with a weighted sum, and refer to an algorithm to quickly detect a target by arranging the strong classifier in sequence.

Recently, r a machine learning method that may recognize a pattern in various situations and quickly learn a numerous number of training data is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a recognizer training method includes selecting training data, generating clusters by clustering the selected training data based on a global shape parameter, and classifying training data from at least one cluster based on a local shape feature.

The global shape parameter may be used to determine a global feature of the selected training data, and the local shape feature may be used to determine a local feature of the training data from the cluster.

The generating may include determining a parameter value of the global shape parameter, determining a parameter vector of the selected training data using the determined parameter value, dividing the parameter vector into data sets, verifying whether a degree of separation between the data sets satisfies a predetermined condition, and storing division information on the generating of the clusters when the degree of separation satisfies the predetermined condition.

The dividing of the parameter vector may include dividing the parameter vector into the data sets based on randomly determined threshold values, and wherein an arbitrary number of the threshold values may be generated.

The degree of separation may be determined based on a mean and a standard deviation of each data set.

The division information on the generating of the clusters may include information on the global shape parameter used to generate the clusters and information on the threshold values used to divide the parameter vector into the data sets.

The degree of separation may satisfy the predetermined condition when a currently determined degree of separation is greatest among degrees of separation determined based on global shape parameters.

The classifying may include determining a feature value of the local shape feature, determining a feature vector of the training data from the cluster based on the determined feature value, dividing the feature vector into data sets, verifying whether an entropy determined based on the data sets satisfies a predetermined condition, and storing division information on the classifying of the training data from the cluster when the entropy satisfies the predetermined condition. The dividing of the feature vector may include dividing the feature vector into the data sets based on randomly determined threshold values, and wherein an arbitrary number of the threshold values are generated. The division information on the classifying of the training data from the cluster may include information on the local shape feature used to classify the training data from the cluster, and information on the threshold values used to divide the feature vector into the data sets. When a currently determined entropy is smallest among entropies determined based on local shape features, the verifying may include determining that the entropy satisfies the predetermined condition.

In another general aspect, a data recognizing method includes reading input data, determining a cluster to which the input data belongs based on learned global shape parameter information, and determining a class of the input data based on the determined cluster and learned local shape feature information.

The learned global shape parameter information may be used to determine a global feature of the input data, and the learned local shape feature information may be used to determine a local feature of the input data.

The determining of the cluster may include determining a parameter value of the input data based on the learned global shape parameter information, and determining the cluster corresponding to the determined parameter value using information on a stored threshold value.

The determining of the class may include loading at least one recognizer to classify data from the determined cluster, and estimating the class of the input data based on the recognizer and the local shape feature information. The estimating of the class may include determining a feature value of the input data based on the local shape feature information, and estimating the class of the input data based on the determined feature value and information on a threshold value stored in the recognizer.

In another general aspect, a non-transitory computer-readable medium may include instructions for a computer to perform one or more methods described above.

In another general aspect, a recognizer training apparatus includes a training data selector to select training data, a clustering unit configured to generate clusters by clustering the selected training data based on a global shape parameter, and a training data classifier to classify training data from at least one cluster based on a local shape feature, wherein the training data selector, clustering unit, and training data classifier include one or more processors and/or memories configured to select training data, generate clusters, and classify training data.

The global shape parameter may determine a global feature of the selected training data, and the local shape feature may determine a local feature of the training data from the cluster.

In another general aspect, a data recognizer includes an input data reader configured to read input data, a cluster determiner configured to determine a cluster to which the input data belongs based on learned global shape parameter information, and a class determiner configured to determine a class of the input data based on the determined cluster and learned local shape feature information, wherein the input data reader, clustering determiner, and class determiner comprise one or more processors and/or memories configured to read input data, determine a cluster, and determine a class.

Other features and aspects will be apparent from the following detailed description, the drawings, and the claims.

### BRIEF DESCRIPTION OF DRAWINGS

FIG. 1 is a diagram illustrating a configuration of a recognizer training apparatus according to an embodiment.

FIG. 2 is a diagram illustrating a configuration of a data recognizer according to an embodiment.

FIGS. 3 and 4 illustrate distributed training structures for training a recognizer according to an embodiment.

FIG. 5 is a flowchart illustrating a method of training a recognizer according to an embodiment.

FIG. 6 is a flowchart illustrating a process of performing clustering on training data according to an embodiment.

FIG. 7 is a flowchart illustrating a process of classifying training data included in a cluster according to an embodiment.

FIGS. 8 and 9 illustrate examples of a global shape parameter according to an embodiment.

FIG. 10 is a diagram illustrating a memory structure of a global shape parameter according to an embodiment.

FIG. 11 is a diagram illustrating an example of a local shape feature according to an embodiment.

FIG. 12 is a flowchart illustrating a method of recognizing data according to an embodiment.

FIG. 13 is a flowchart illustrating a process of recognizing input data with respect to global branches according to an embodiment.

FIG. 14 is a flowchart illustrating a process of recognizing input data with respect to local sprigs according to an embodiment.

FIG. 15 illustrates an example of training data according to an embodiment.

FIG. 16 illustrates an example of using information extracted from a leaf node of local sprigs according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

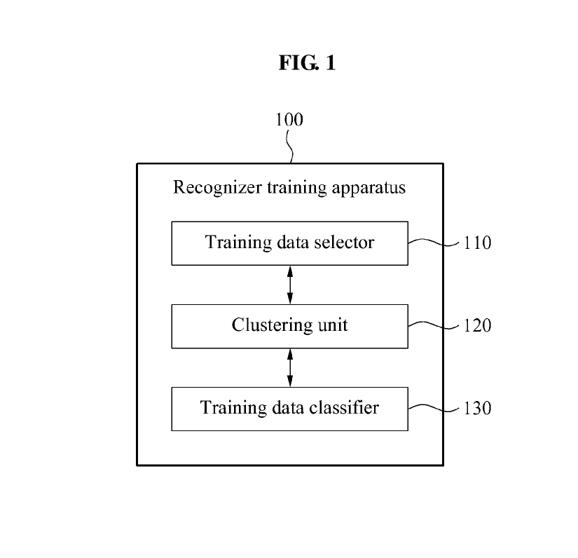

Referring to FIG. 1, the recognizer training apparatus 100 includes a training data selector 110, a clustering unit 120, and a training data classifier 130. In an embodiment, the recognizer training apparatus 100, training data selector 110, clustering unit 120, and training data classifier 130 represent one or more processors, memories, or both. The recognizer training apparatus 100 trains a recognizer using training data. For example, the training data may include image data, voice data, text data, and bio data. Here, types of the training data may not be limited to a particular type of data.

The recognizer training apparatus 100 determines an optimal feature extracting method from among multiple feature extracting methods. The recognizer training apparatus 100 extracts, using the determined feature extracting method, an optimal feature suitable for various situations from data.

The recognizer training apparatus 100 trains a recognizer having a reduced processing time and number of processing steps by hierarchically configuring the recognizer. The recognizer training apparatus 100 generates a hierarchically classified structure. The recognizer training apparatus 100 divides, using various features, the training data into separated bunches or clusters and trains individual recognizers to improve a recognition rate. The recognizer training apparatus 100 generates the classified structure composed of global branches and local sprigs. Sprigs are considered branch nodes connected to multiple leaf nodes.

In the global branches, an upper portion of the classified structure, the recognizer training apparatus 100 performs clustering on the training data. In the local sprigs, a lower portion of the classified structure, the recognizer training apparatus 100 may perform classification or regression of training data. The recognizer recognizes a class or a type of input data using the classified structure. The clustering may reduce an overall depth of a classified structure and improve a searching speed. In the local sprigs of the classified structure, an exhaustive training may be performed on a cluster.

For example, a global branch has a smaller number of branches and a smaller depth than a local sprig. In the global branch, an unsupervised learning is performed. In the local sprig, a supervised learning is performed. In the global branch, an optimal global shape parameter is determined from among heterogeneous global shape parameters. In the local sprig, a local shape feature is determined from among heterogeneous local shape features. A decision bound among data is finer in the local sprig than in the global branch.

The recognizer training apparatus 100 improves the recognition rate of the recognizer and accuracy of the regression by configuring the classified structure with a small number of the global branches in the upper portion and a large number of the local sprigs in the lower portion to be an ensemble. Here, one global branch is linked to a plurality of local sprigs.

The training data selector 110 selects training data to train the recognizer. For example, the training data selector 110 randomly selects the training data on an equal probability basis.

The clustering unit 120 learns the global branches. For example, the clustering unit 120 performs the unsupervised learning that may not require a ground-truth labeling. The global branch may be a single tree or multiple trees. The clustering unit 120 performs clustering on the training data selected based on a global shape parameter. The global shape parameter is used to determine a global feature of the selected training data. The clustering unit 120 generates, by performing the clustering, clusters which refers to gatherings of training data. The clustering unit 120 selects the global shape parameter to be tested from among heterogeneous global shape parameters. Subsequently, the clustering unit 120 determines a parameter value of the training data based on the selected global shape parameter. The clustering unit 120 determines parameter values of the global shape parameters.

The clustering unit 120 normalizes the determined parameter values. The clustering unit 120 normalizes scales of the parameter values. Subsequently, the clustering unit 120 configures a parameter vector for each individual training data. The clustering unit 120 randomly generates threshold values and divides parameter vectors into data sets based on the generated threshold values. Here, an arbitrary number of threshold values may be generated.

The clustering unit 120 determines a mean and a standard deviation for each of the data sets, and determines a degree of separation among the data sets based on information on the determined mean and standard deviation. The degree of separation among the data sets indicates a distance separating the data sets.

The clustering unit 120 verifies whether the determined degree of separation satisfies a predetermined condition, and stores division information based on a result of the verifying. For example, when a currently determined degree of separation is greatest among degrees of separation, determined based on the global shape parameters, the clustering unit 120 determines that the degree of separation satisfies the predetermined condition. The division information includes information on the global shape parameter used to generate the clusters and information on the threshold values used to divide the parameter vector into the data sets.

The clustering unit 120 proceeds with learning of subnodes of the global branch. When learning of the global branches is terminated, the training data classifier 130 learns the local sprigs.

The training data classifier 130 learns the local sprigs. For example, the training data classifier 130 may perform the supervised learning through the ground-truth labeling. For example, the local sprig may be provided in a form of multiple trees.

The training data classifier 130 classifies training data included in at least one cluster based on a local shape feature. The local shape feature is used to determine a data set divided by the global branches or a local feature of the training data included in the cluster.

The training data classifier 130 randomly selects the training data included in the cluster. The training data classifier 130 selects a local shape feature to be tested from among heterogeneous local shape features and determines a feature value. The training data classifier 130 determines feature values of the local shape features.

The training data classifier 130 normalizes the determined feature values. The training data classifier 130 normalizes scales of the feature values. Subsequently, the training data classifier 130 configures a feature vector for each individual training data.

The training data classifier 130 randomly generates threshold values and divides feature vectors into data sets based on the generated threshold values. Here, an arbitrary number of the threshold values may be generated.

The training data classifier 130 determines information entropy of the data sets. The training data classifier 130 determines the information entropy based on distribution of the data sets. The training data classifier 130 determines whether the determined entropy satisfies a predetermined condition. For example, when a currently determined entropy is the smallest among entropies determined based on the local shape features, the training data classifier 130 determines that the entropy satisfies the predetermined condition. When the entropy satisfies the predetermined condition, the training data classifier 130 stores the division information. The division information includes information on the local shape features used to classify the training data included in each cluster and information on the threshold values used to divide the feature vector into the data sets.

The training data classifier 130 proceeds with learning of subnodes of the local sprigs. When arriving at a leaf node of a local sprig, the training data classifier 130 stores, in the leaf node of the local sprig, information on result data, e.g. the divided data sets. For example, the information to be stored in the leaf node may include probability information associated with a class of a target to be recognized, regression information associated with a value to be estimated, or index information on a direct link corresponding to data in the local sprigs. The information to be stored in the leaf node may be converted into various forms and stored in the leaf node.

Through the process described above, a recognizer having a classified structure with a lower depth, a faster processing speed, and an improved recognition rate may be generated.

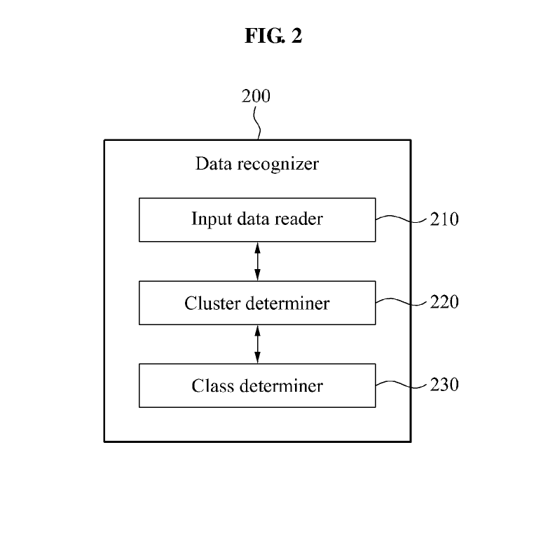

Referring to FIG. 2, the data recognizer 200 may include an input data reader 210, a cluster determiner 220, and a class determiner 230. In an embodiment, the recognizer 200, input data reader 210, clustering determiner 220, and class determiner 230 represent one or more processors and/or memories.

The data recognizer 200 recognizes input data based on learned information. The data recognizer 200 determines a class of the input data using a classified structure composed of global branches and local sprigs. In a global branch, the data recognizer 200 determines a cluster to which the input data belongs. In a local sprig, the data recognizer 200 determines a class of the input data using individual recognizers corresponding to each of clusters.

The input data reader 210 reads the input data to be recognized.

The cluster determiner 220 determines the cluster to which the input data belongs based on learned global shape parameter information. The cluster determiner 220 reads the global shape parameter information stored in an uppermost node of the global branches. In the global branch of a classified structure, the cluster determiner 220 determines the cluster to which the input data belongs based on the learned global shape information. For example, the global branch may be provided in a form of a single tree or multiple trees.

The cluster determiner 220 determines a parameter value of the input data based on the learned global shape parameter information. The cluster determiner 220 determines a cluster corresponding to the determined parameter value using information on stored threshold values.

For example, the cluster determiner 220 conducts a search of ranges indicated by the stored threshold values for a range in which the parameter value is included and visits, or searches, a subnode of the global branch. When the visited, or searched, subnode is a leaf node of the global branch, the cluster determiner 220 terminates a recognition process performed in the global branch. Subsequently, the class determiner 230 starts the recognition process in the local sprigs.

The class determiner 230 determines the class of the input data based on the cluster and learned local shape feature information. The class determiner 230 reads the local shape feature information stored in an uppermost node of the individual local sprigs. In the local sprigs of the classified structure, the class determiner 230 recognizes the class of the input data using the learned local shape information or regress to a result value.

The class determiner 230 loads at least one recognizer to classify data included in a cluster. The class determiner 230 estimates the class of the input data based on the recognizer and the local shape feature information. The class determiner 230 determines a feature value of the input data based on the local shape feature information and estimates the class of the input data based on the determined feature value and a threshold value stored in the recognizer.

For example, the class determiner 230 conducts a search of ranges indicated by the stored threshold values for a range in which the feature value is included and determines a subnode of a local sprig to be visited. When the visited subnode is a leaf node of the local sprig, the class determiner 230 extracts learned information from the leaf node of the local sprig. Information stored in the leaf node may include probability information associated with a class of a target to be recognized, regression information on a value to be estimated, or index information on a direct link corresponding to data in the local sprigs.

The class determiner 230 repeatedly performs the process described above on the individual local sprigs and combines information extracted from leaf nodes. The class determiner 230 recognizes the class or a type of the input data based on the information extracted from the leaf nodes.

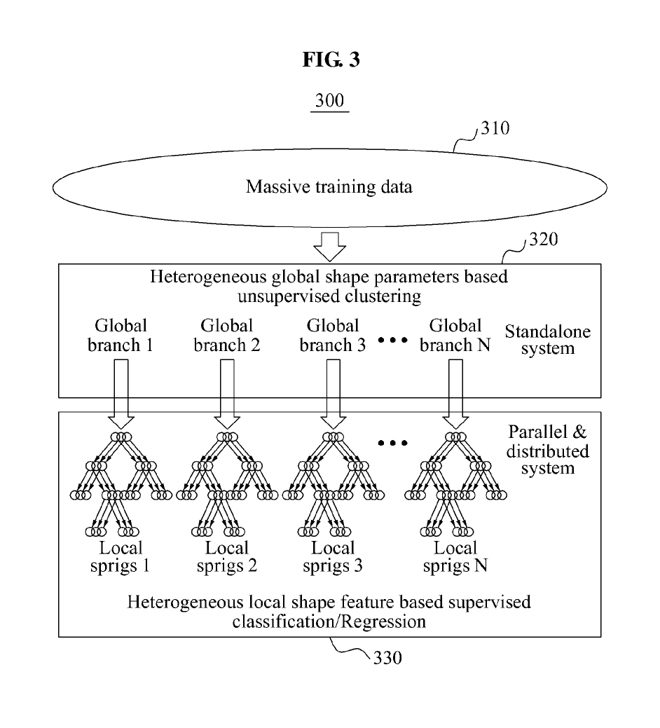

Referring to FIG. 3, a recognizer training apparatus trains the recognizer based on a process shown in the distributed training structure 300. When massive training data 310 is input, the recognizer training apparatus performs unsupervised learning of global branches using heterogeneous global shape parameters as shown in 320. As a result of the unsupervised learning, clusters indicating groups of training data are generated. The recognizer training apparatus performs the unsupervised learning of the global branches in a standalone system.

The recognizer training apparatus learns individual local sprigs in each of the generated clusters. The recognizer training apparatus performs a supervised learning of the local sprigs using heterogeneous local shape features as shown in 330. The recognizer training apparatus performs the supervised learning of the local sprigs in a parallel and distributed system. As a result of the supervised learning, a classified structure in a bush form (i.e a short tree having multiple branches and sprigs) may be generated.

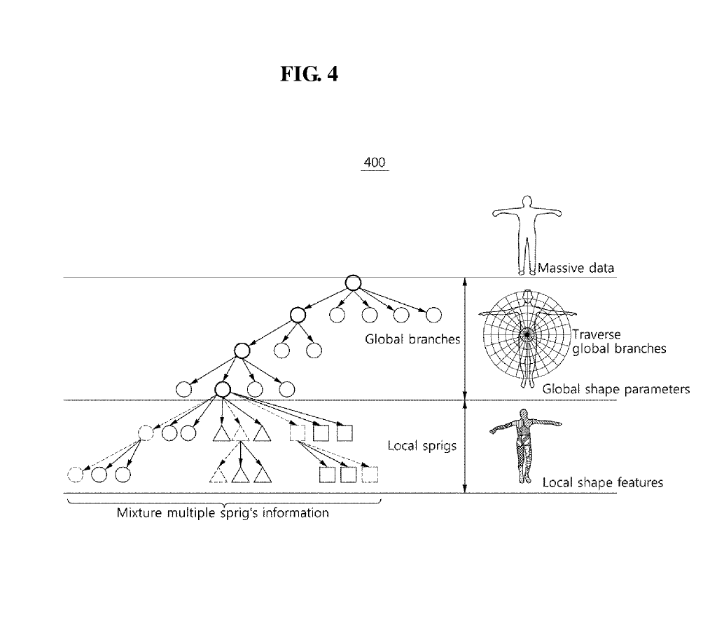

FIG. 4 illustrates a distributed training structure 400 having a classified structure in a bush form. The distributed training structure 400 generated as a result of learning performed by a recognizer training apparatus is composed of global branches in an upper portion and local sprigs in a lower portion. In general, the global branches may be provided in a single tree or multiple trees. A number of branches ramified from a parent node of the tree into child nodes may be an arbitrary number.

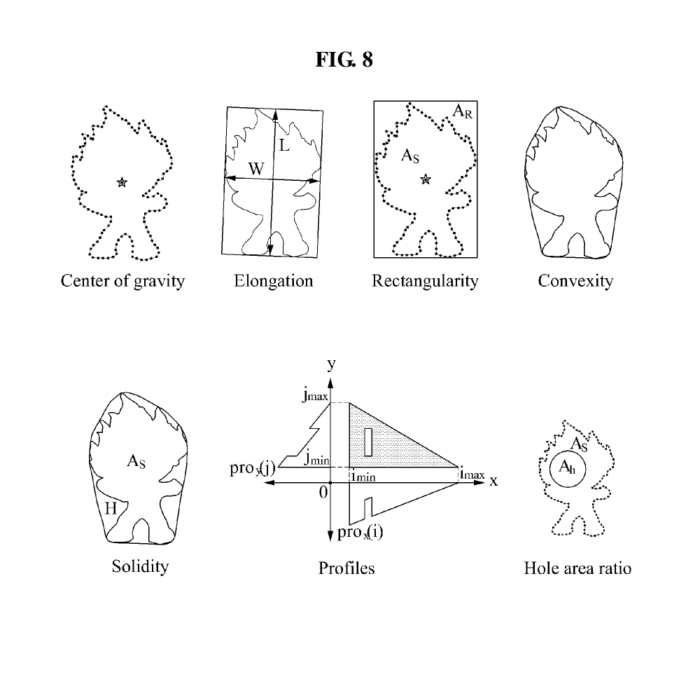

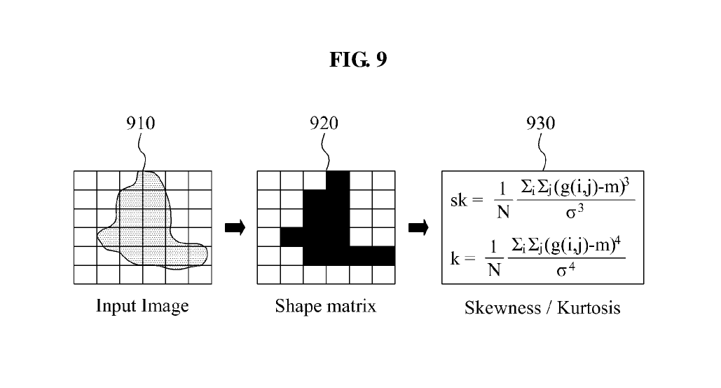

In the global branches, a parameter for a global shape of a target to be learned is extracted using a global shape parameter, and the extracted parameter is learned. The parameter for the global shape of the target is extracted using a parameter extracting method that is unsusceptible to local variations and conducive to performing fast calculations. For example, the global shape parameter may include a three-dimensional (3D) center of gravity, 3D elongation, convexity, and skewness. A more detailed description of the global shape parameter will be provided with reference to FIGS. 8 and 9.

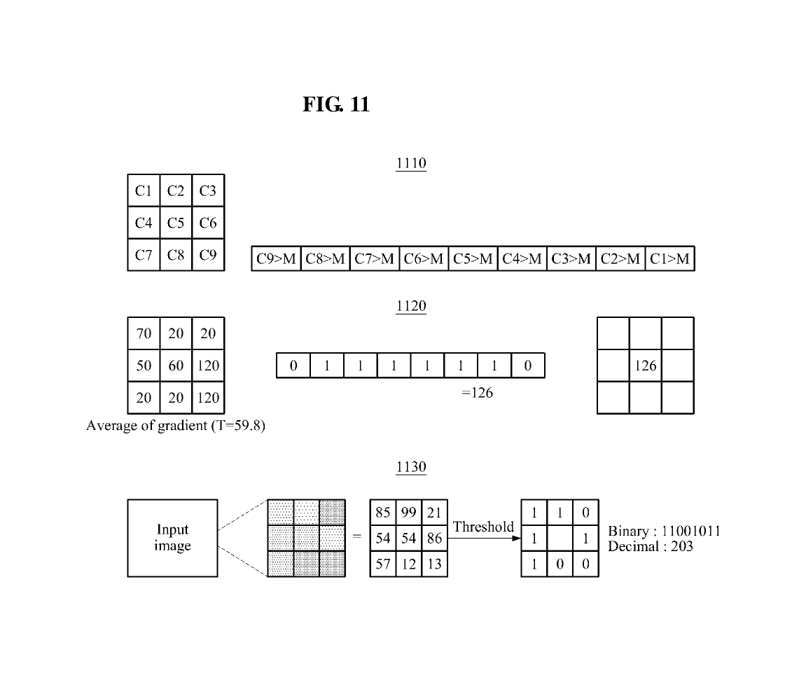

In the local sprigs, a feature for a local shape of the target is extracted using a local shape feature, and the extracted feature is learned. The feature for the local shape of the target is extracted using a fine feature extracting method that distinguishes the local variations. For example, the local shape feature may include modified census transform (MCT), local gradient pattern (LGP), and local binary pattern (LBP). A more detailed description of the local shape parameter will be provided with reference to FIG. 11.

The distributed training structure 400 generated through the process described above may be used to recognize a type of the input data or estimate a type of the input data based on value regression.

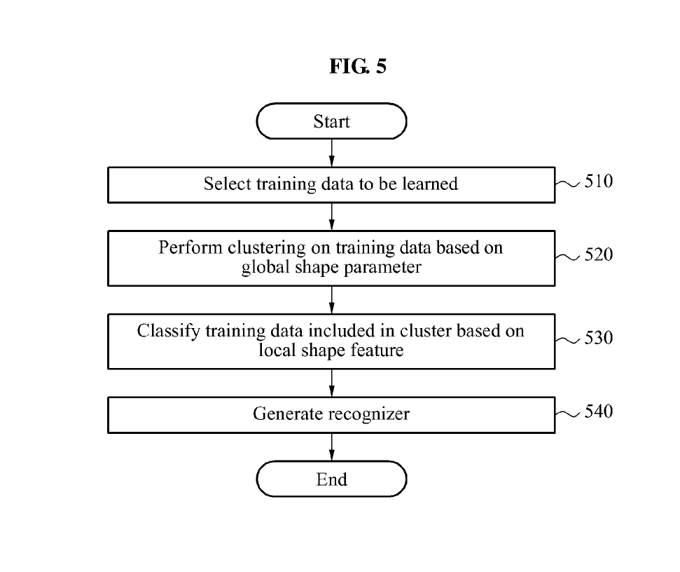

Referring to FIG. 5, in operation 510, a recognizer training apparatus selects training data to train a recognizer. For example, the recognizer training apparatus may randomly select the training data on an equal probability basis. In operation 520, the recognizer training apparatus clusters the training data based on a global shape parameter. Subsequent to the clustering, the recognizer training apparatus generates clusters which refer to gatherings of the training data. The recognizer training apparatus may select a global shape parameter to be tested from among global shape parameters. The recognizer training apparatus determines a parameter value of the training data using the selected global shape parameter. The recognizer training apparatus determines a parameter value of the global shape parameters.

The recognizer training apparatus determines a parameter vector of the training data using the determined parameter value. The recognizer training apparatus divides the parameter vector into data sets and verifies whether a degree of separation among the data sets satisfies a predetermined condition. When the degree of separation satisfies the predetermined condition, division information used for the generating of the clusters is stored.

In operation 530, the recognizer training apparatus classifies training data included in at least one cluster based on a local shape feature. The recognizer training apparatus randomly selects the training data included in the cluster. The recognizer training apparatus selects a local shape feature to be tested from among local shape features and determines a feature value. The recognizer training apparatus determines feature values of the local shape features.

The recognizer training apparatus normalizes scales of the feature values. Subsequently, the recognizer training apparatus configures a feature vector for each element of individual training data. The recognizer training apparatus divides feature vectors into data sets based on a threshold value.

The recognizer training apparatus determines entropy of the data sets. The recognizer training apparatus determines the entropy based on distribution of the data sets. The recognizer training apparatus verifies whether the entropy satisfies a predetermined condition. When the entropy satisfies the predetermined condition, the recognizer training apparatus stores division information. The recognizer training apparatus proceeds with learning of subnodes of a local sprig. When reaching a leaf node of the local sprig, the recognizer training apparatus stores, in the leaf node of the local sprig, information about data remaining after division.

In operation 540, the recognizer training apparatus generates a recognizer using the division information obtained in each step and information on the remaining data.

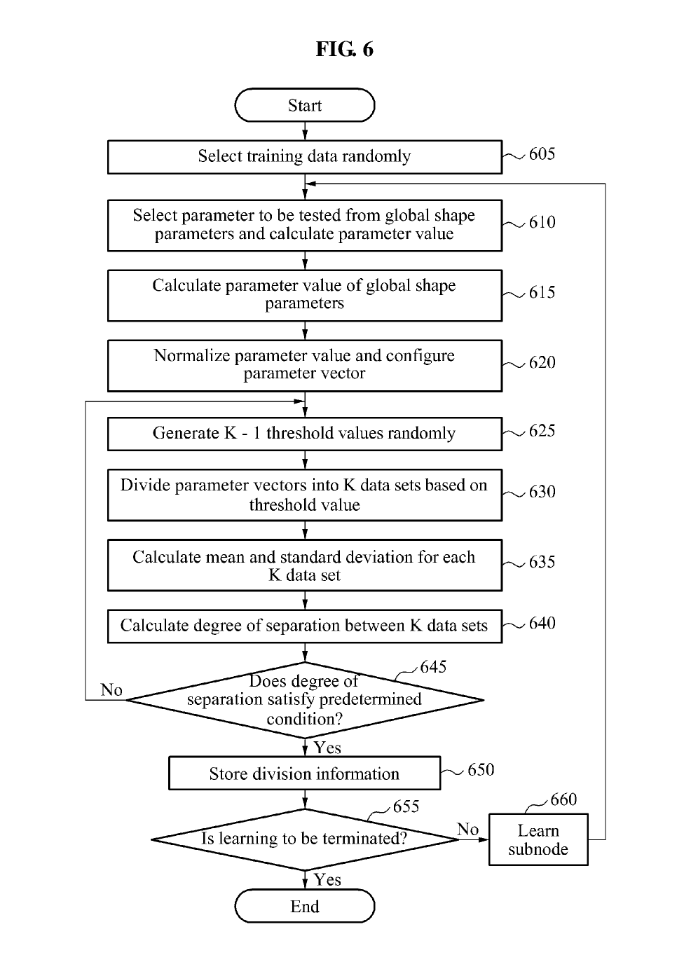

FIG. 6 is a flowchart illustrating a process of performing clustering on training data according to one or more embodiments. Referring to FIG. 6, a process of learning global branches is shown. In operation 605, a recognizer training apparatus selects training data to be learned. For example, the recognizer training apparatus may randomly select the training data on an equal probability basis.

In operation 610, the recognizer training apparatus selects a global shape parameter to be tested from among heterogeneous global shape parameters. Subsequently, the recognizer training apparatus calculates a parameter value of the training data using the selected global shape parameter. For example, the recognizer training apparatus selects a global shape parameter from among the global shape parameters, such as a center of gravity, elongation, rectangularity, and convexity, and calculate the parameter value of the training data with respect to the selected global shape parameter.

In operation 615, the recognizer training apparatus calculates a parameter value of the global shape parameters by performing operation 610 multiple times. For example, the recognizer training apparatus may (1) calculate a parameter value of all heterogeneous global shape parameters, (2) calculate a parameter value of only global shape parameters randomly selected, or (3) calculate a parameter value of only global shape parameters selected by a user.

In operation 620, the recognizer training apparatus normalizes parameter values calculated in operation 615. A maximum range and a minimum range of the parameter values calculated based on the global shape parameters may be different or the same. The recognizer training apparatus normalizes scales of the parameter values. Subsequently, the recognizer training apparatus configures a parameter vector for each element of individual training data.

In operation 625, the recognizer training apparatus randomly generates a number, for example, “K-1,” of threshold values. Here, “K” denotes a randomly determined integer greater than or equal to “2”. In 630, the recognizer training apparatus divides parameter vectors into a number of data sets, for example, “K,” based on the K-1 threshold values.

In operation 635, the recognizer training apparatus calculates a mean and a standard deviation for each of the K data sets.

In operation 640, the recognizer training apparatus calculates a degree of separation, or a clustering strength, among the K data sets using the mean and the standard deviation obtained from operation 635. In operation 645, the recognizer training apparatus verifies whether the degree of separation satisfies a predetermined condition. For example, when a currently calculated degree of separation is greatest or when the degree of separation is greater than the predetermined standard degree of separation, the recognizer training apparatus determines that the degree of separation satisfies the predetermined condition.

According to an embodiment, the recognizer training apparatus uses a Gaussian likelihood, “D,” as an objective function to calculate a degree of separation between two clusters, as represented by Equation 1.

$$D = {\sum }_{i = 1}^{k} {\sum }_{j = 1}^{k} \frac{\vert {μ}_{i} - {μ}_{j} \vert}{\sqrt{( {σ}_{i}^{2} + {σ}_{j}^{2} ) / 2}} , i \neq j \qquad [ Equation 1 ]$$

In Equation 1, when the mean, “μ,” of the “k” clusters is max-marginalized and the standard deviation, “σ,” is minimized, the Gaussian likelihood, “D,” is greater. Also, the greater the Gaussian likelihood, “D,” the larger the degree of separation between the two clusters. Also, the greater a degree of separation among the clusters or a density of elements in each cluster, the greater the Gaussian likelihood, “D”.

According to another embodiment, the recognizer training apparatus uses an imbalance feature, “D_{b},” as shown in Equation 2 in order to calculate a degree of separation between two clusters. Based on the imbalance feature, “D_{b},” whether the sets included in each cluster are equally distributed among the clusters may be determined.

$${D}_{b} = {\sum }_{i = 1}^{k} {\sum }_{j = 1}^{k} \vert log \vert {s}_{i} \vert - log \vert {s}_{j} \vert \vert , i \neq j \qquad [ Equation 2 ]$$

In Equation 2, the lower a difference in the number, “S,” of data points included in each cluster among the “k” clusters, the lower the imbalance feature, “D_{b}”. Also, the lower the imbalance feature, “D_{b},” the greater the degree of separation between the two clusters.

According to still another embodiment, the recognizer training apparatus calculates the degree of separation using both Equations 1 and 2.

When the degree of separation satisfies the predetermined condition, the recognizer training apparatus stores division information, in operation 650. The division information includes information on the global shape parameters used to generate the clusters and information on the “K-1” threshold values used to divide the parameter vector into the data sets.

In operation 655, the recognizer training apparatus determines whether to terminate the learning of a global branch. For example, when (1) a quantity of the training data included in a cluster satisfies the predetermined condition, (2) the degree of separation calculated in operation 640 satisfies the predetermined condition, or (3) a level of the global branch exceeds a predetermined standard, the recognizer training apparatus terminates the learning of the global branch. When the learning of the global branch is terminated, the recognizer training apparatus starts learning a local sprig.

When the recognizer training apparatus determines not to terminate the learning of the global branch, the recognizer training apparatus proceeds with learning of subnodes of the global branch, in operation 660. The recognizer training apparatus performs a series of similar processes presented in operations 605 through 660 for the subnodes of the global branch.

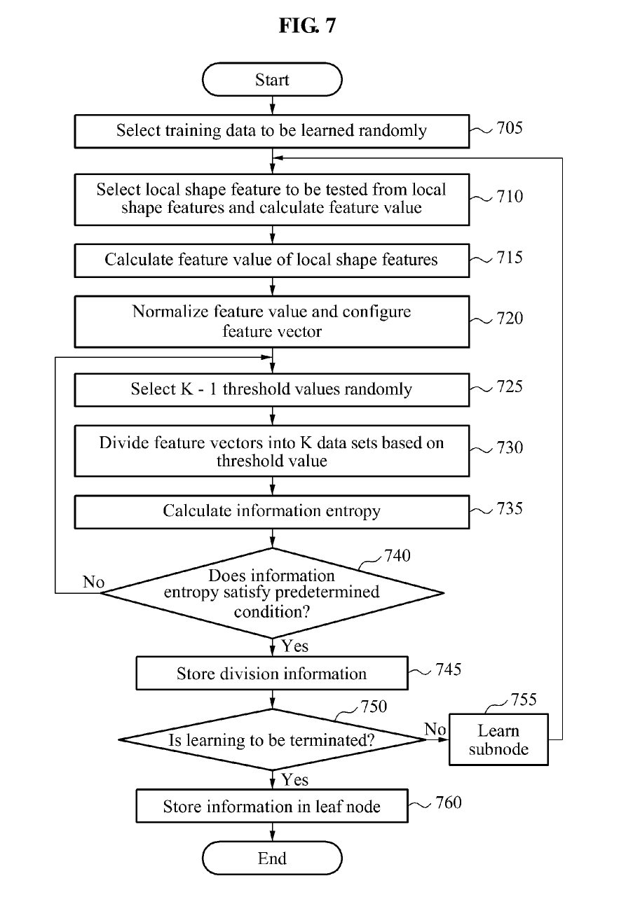

FIG. 7 is a flowchart illustrating a process of classifying training data included in a cluster according to one or more embodiments. Referring to FIG. 7, a process of learning local sprigs subsequent to the learning of a global branch is shown. In operation 705, a recognizer training apparatus randomly selects training data to be learned. For example, the recognizer training apparatus randomly selects the training data included in the cluster on an equal probability basis. Here, the training data indicates a data set divided by global branches.

In operation 710, the recognizer training apparatus selects a local shape feature to be tested from among heterogeneous local shape features and calculate a feature value.

In operation 715, the recognizer training apparatus performs operation 710 multiple times and calculates feature values of the local shape features. For example, the recognizer training apparatus may (1) calculate a feature value of all the heterogeneous local shape features, (2) calculate a feature value of only the randomly selected local shape features, or (3) calculate a feature value of only the local shape features selected by a user.

In operation 720, the recognizer training apparatus normalizes the feature values calculated in operation 715. Different maximum and minimum ranges of the feature values are calculated based on the local shape features. The recognizer training apparatus normalizes scales of the feature values. Subsequently, the recognizer training apparatus configures a feature vector for each element of individual training data.

In operation 725, the recognizer training apparatus may randomly generate a number, for example, “K-1,” of threshold values. Here, the “K” denotes an arbitrarily determined integer greater than or equal to “2”. In operation 730, the recognizer training apparatus divides feature vectors into a number, for example, “K,” of data sets based on the “K-1” threshold values.

In operation 735, the recognizer training apparatus calculates information entropy on the K data sets. The recognizer training apparatus may calculate the information entropy based on distribution of the K data sets. For example, the recognizer training apparatus determines the information entropy of the K data sets using Equation 3.

$$E ( {D}_{k} ) = - {\sum }_{i = 1}^{c} P ( {c}_{i} \vert {D}_{k} ) log P ( {c}_{i} \vert {D}_{k} ) \qquad [ Equation 3 ]$$

Here, “Dₖ” denotes data included in a kth data set and “cᵢ” denotes an ith class. “E(Dₖ)” denotes information entropy of the data included in the kth data set.

Information entropy, “E(D),” of all data, “D,” may be determined using Equation 4.

$$E ( D ) = {\sum }_{i = 1}^{k} \frac{\vert {D}_{i} \vert}{\vert D \vert} \times E ( {D}_{i} ) \qquad [ Equation 4 ]$$

Here, “Dᵢ” denotes data included in an “i”th data set and “E(Dᵢ)” denotes information entropy of the ith data set.

In operation 740, the recognizer training apparatus determines whether the information entropy satisfies a predetermined condition. For example, when a currently calculated information entropy is a minimum value or the information entropy is less than a predetermined standard information entropy, the recognizer training apparatus determines that the information entropy satisfies the predetermined condition. Lower information entropy indicates that the training data is more precisely classified in the local sprigs and an increase in a recognition rate of a recognizer.

When the information entropy satisfies the predetermined condition, the recognizer training apparatus stores division information in operation 745. The division information includes information on the local shape features used to classify the training data included in each cluster and information on the K-1 threshold values used to divide the feature vector into the data sets.

In operation 750, the recognizer training apparatus determines whether to terminate the learning of the local sprigs. For example, when (1) the information entropy calculated in operation 735 satisfies the predetermined condition, (2) a level of a local sprig exceeds a predetermined condition, or (3 ) a quantity of remaining data included in a cluster satisfies a predetermined condition, the recognizer training apparatus terminates the learning of the local sprig.

In operation 755, subsequent to the recognizer training apparatus determining not to terminate the learning of the local sprig, the recognizer training apparatus proceeds with the learning of subnodes of the local sprig. The recognizer training apparatus performs a series of similar processes presented in operations 705 through 755 for the subnodes of the local sprig.

In operation 760, the recognizer training apparatus stores information on data remaining after division in a leaf node of the local sprig. For example, the information stored in the leaf node may include probability information associated with a class of a target to be recognized, regression information on a value to be estimated, or index information on a direct link corresponding to data in the local sprigs. The information stored in the leaf node may be converted to various forms and stored in the leaf node.

Referring to FIGS. 8 and 9, the global shape parameter indicates a shape descriptor that distinguishes only a shape having a relatively large shape difference compared to a local shape feature. The global shape parameter may remain robust or invariant against local shape variations. Thus, using the global shape parameter is efficient when performing clustering on data.

In general, the global shape parameter distinguishes only the shape having a large shape difference and thus, a calculation speed using the global shape parameter is faster than a calculation speed using the local shape feature. The recognizer training apparatus uses the global shape parameter as a classifier used for performing clustering on the data.

For example, the global shape parameter includes shape parameters as shown in FIG. 8 including a 3D center of gravity, for example, gₓ, g_{y}, and g_{z}, 3D elongation, for example, XY elongation, YX elongation, ZX elongation, XZ elongation, ZY elongation, and YZ elongation, 2D rectangularity, convexity, solidity, profiles, and a hole area ratio, and shape parameters as shown in FIG. 9 including skewness and kurtosis. For example, a parameter value of the global shape parameters may be determined using Equation 5.

$${g}_{x} = ( \frac{1}{N} {\sum }_{i = 1}^{N} {x}_{i} - {Min}_{x} ) / Width \\ {g}_{y} = ( \frac{1}{N} {\sum }_{i = 1}^{N} {y}_{i} - {Min}_{y} ) / Height {g}_{z} = ( \frac{1}{N} {\sum }_{i = 1}^{N} {z}_{i} - {Min}_{z} ) / Depth \qquad [ Equation 5 ]$$

Here, “Width,” “Height,” and “Depth” denote a width, a height, and a depth of a shape, respectively.

The 3D elongation, “Elo,” is determined using Equation 6.

Elo=1−W/L [Equation 6]

Here, “W” is {X, Y, Z} and “L” is {X, Y, Z}. Elements of W are not identical to elements of L, and L is not “0.” W and L denote a width and a height of a shape, respectively.

The 2D rectangularity is determined using Equation 7.

Rectangularity=A_{S}/A_{R} [Equation 7]

Here, A_{S} denotes a shape area and “A_{R}” denotes a bounding box area.

The skewness and the kurtosis indicating a textural feature are determined using the following process. For example, the recognizer training apparatus converts an input image 910 to a shape matrix 920 and determine a skewness parameter or a kurtosis parameter 930 based on the shape matrix 920. The skewness parameter, “sk,” is determined using Equation 8.

$$sk = \frac{1}{N} \frac{{Σ}_{i} {{Σ}_{j} ( g ( i , j ) - m )}^{3}}{{σ}^{3}} \qquad [ Equation 8 ]$$

The kurtosis parameter, “k,” is determined using Equation 9.

$$k = \frac{1}{N} \frac{{Σ}_{i} {{Σ}_{j} ( g ( i , j ) - m )}^{4}}{{σ}^{4}} \qquad [ Equation 9 ]$$

In Equations 8 and 9, “m” denotes a mean of a shape matrix and “σ” denotes a standard deviation of the shape matrix.

The global shape parameter described in the foregoing is used as an example and thus, a scope of example embodiments is not limited to the types of the global shape parameter described herein.

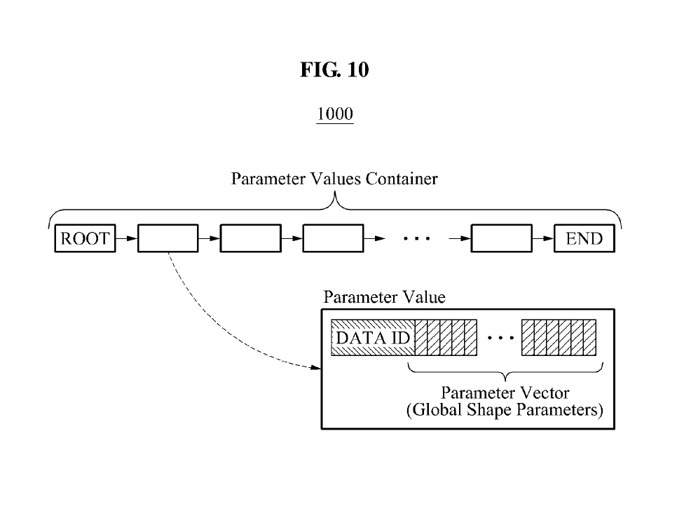

FIG. 10 is a diagram illustrating a memory structure 1000 of a global shape parameter according to an embodiment. A parameter value of the global shape parameter is calculated to be a one-dimensional real value. A recognizer training apparatus calculates parameter values of global shape parameters and generates a multi-dimensional parameter vector based on the parameter values. Individual data of training data has a corresponding parameter vector.

The memory structure 1000 of the global shape parameter includes a parameter values container 1001 to store the parameter values 1002. The parameter values container 1001 stores multi-dimensional parameter vectors corresponding to the global shape parameters.

Referring to FIG. 11, the local shape feature indicates a shape descriptor that distinguishes a relatively small shape difference compared to a global shape parameter. Thus, the local shape feature is useful for classification or regression of data.

The local shape feature includes a modified census transform (MCT) 1110, a local gradient pattern (LGP) 1120, and a local binary pattern (LBP) 1130. For example, the MCT 1110 is obtained by searching for a brightness value in a 3×3 window and performing a 9 bit encoding on the brightness value. The LGP 1120 is obtained by searching for a gradient value in a 3×3 window and performing an 8 bit encoding on the gradient value. The LBP 1130 is obtained by comparing, using a 3×3 kernel, a pixel value of a pixel to a pixel value of a neighboring pixel, representing a result in a binary form, and combining and converting binary information to a decimal number.

The local shape feature described above is used as an example and thus, a scope of embodiments are not limited to the types of the local shape features described herein.

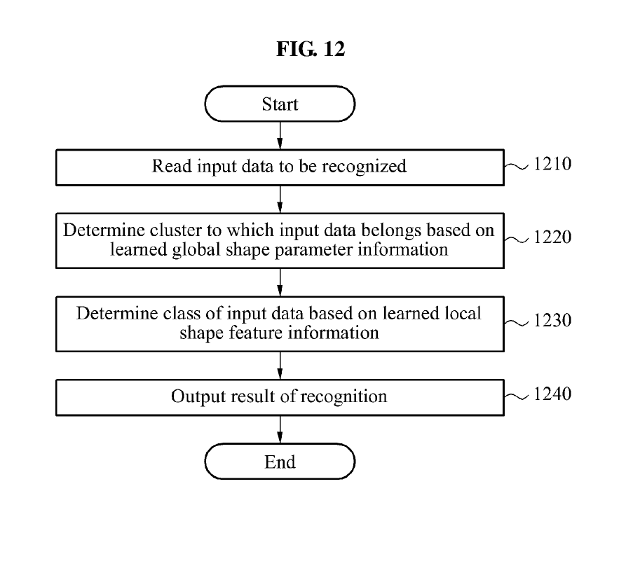

FIG. 12 is a flowchart illustrating a data recognizing method according to an embodiment. Referring to FIG. 12, in operation 1210, a data recognizer reads input data to be recognized. In operation 1220, the data recognizer determines a cluster to which the input data belongs based on learned global shape parameter information. The data recognizer determines a parameter value of the input data based on the learned global shape parameter information. Subsequently, the data recognizer determines the cluster corresponding to the determined parameter value using information on a stored threshold value.

The data recognizer searches for a range in which the parameter value is included within a range indicated by the stored threshold value and determine a subnode of a global branch to be visited. The cluster to which the input data belongs is determined by determining a leaf node of the global branch.

In operation 1230, the data recognizer determines a class of the input data based on the determined cluster and learned local shape feature information. The data recognizer loads at least one recognizer to classify data included in the determined cluster. The data recognizer estimates the class of the input data based on the recognizer and the local shape feature information. The data recognizer determines a feature value of the input data based on the local shape feature information. The data recognizer estimates the class of the input data based on the determined feature value and the stored threshold value. The data recognizer determines the class of the input data using information stored in a leaf node of a local sprig. The information stored in the leaf node of the local sprig includes probability information on a class of a target to be recognized, regression information on a value to be estimated, and index information on a direct link corresponding to data in local sprigs.

In operation 1240, as a result of recognizing, the data recognizer outputs the determined class of the input data.

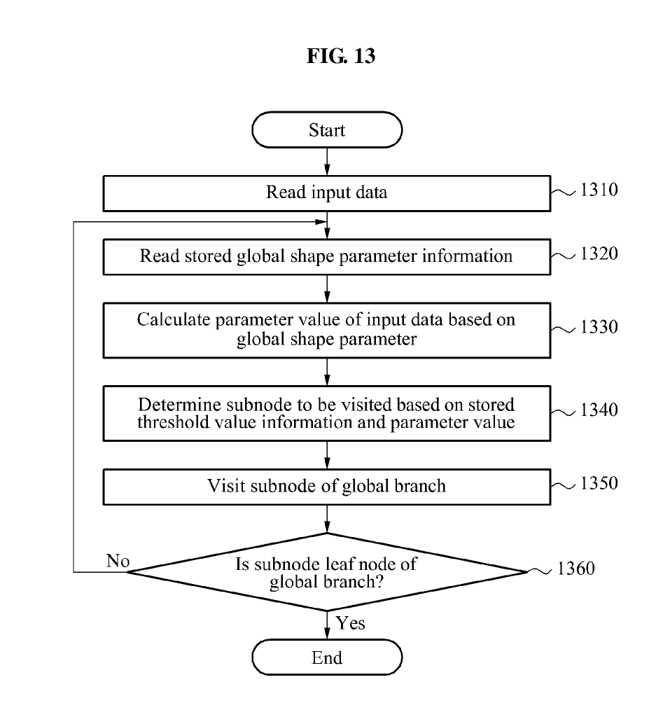

FIG. 13 is a flowchart illustrating a process of recognizing input data with respect to global branches according to another embodiment. Referring to FIG. 13, in operation 1310, a data recognizer reads input data to be recognized.

In operation 1320, the data recognizer reads global shape parameter information stored in an uppermost node of the global branches. In operation 1330, the data recognizer calculates a parameter value of the input data based on the read global shape parameter information. In operation 1340, the data recognizer searches for a range in which the parameter value calculated in operation 1330 is included based on information on a stored threshold value. The data recognizer searches for the range in which the parameter value is included within a range indicated by a K-1 threshold values and determines a subnode of a global branch to be visited. In operation 1350, the data recognizer visits the subnode of the global branch determined in operation 1340. In operation 1360, when the visited subnode is a leaf node of the global branch, the data recognizer terminates the recognizing process in the global branch and starts the recognizing process in a local sprig. A cluster to which the input data belongs is determined by determining the leaf node of the global branch. When the visited subnode is not the leaf node of the global branch, the data recognizer perform a similar process presented in operations 1320 through 1360 on the visited subnode.

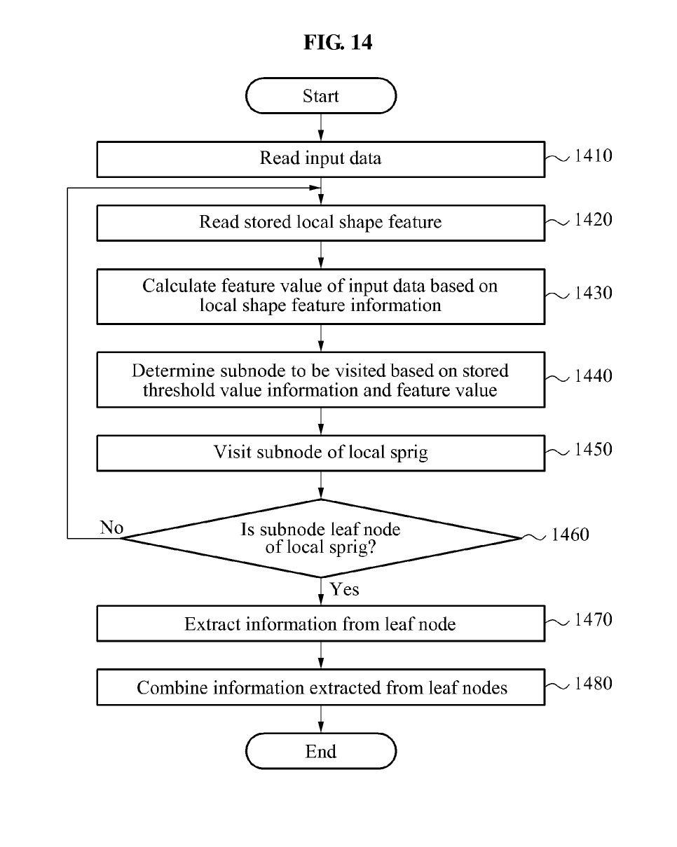

FIG. 14 is a flowchart illustrating a process of recognizing input data with respect to local sprigs according to an embodiment. The local sprigs are composed of individual local sprigs.

In operation 1410, a data recognizer reads input data to be recognized. In operation 1420, the data recognizer reads local shape feature information stored in an uppermost node of the individual local sprigs. In operation 1430, the data recognizer calculates a feature value of the input data based on the read local shape feature information. In operation 1440, the data recognizer searches for a range in which the feature value calculated in operation 1430 is included based on information on stored threshold values. The data recognizer searches for the range in which the feature value is included within a range indicated by a K-1 threshold values stored in the data recognizer and determine a subnode of a local sprig to be visited. In operation 1450, the data recognizer visits the determined subnode of the local sprig. In operation 1460, when the visited subnode is determined not to be a leaf node of the local sprig, the data recognizer performs an identical process of operations 1420 through 1460 on the visited subnode.

When the visited subnode is determined to be the leaf node of the local sprig, the data recognizer extracts learned information from the leaf node of the local sprig in operation 1470. The information stored in the leaf node of the local sprig includes probability information on a class of a target to be recognized, regression information on a value to be estimated, and index information on a direct link corresponding to data in the local sprigs.

In operation 1480, the data recognizer repeatedly performs operations 1410 through 1470 on the individual local sprigs and combines information extracted from leaf nodes. The data recognizer recognizes the class or a type of the input data based on the information extracted from the leaf nodes.

For example, when recognizing a class of input data, “x,” a probability, “P,” of each class, “c,” stored in a leaf node of a local sprig composed of “S” individual local sprigs may be determined using Equation 10.

$$P ( c \vert x ) = \frac{1}{S} {\sum }_{s = 1}^{S} {P}_{s} ( c \vert x ) \qquad [ Equation 10 ]$$

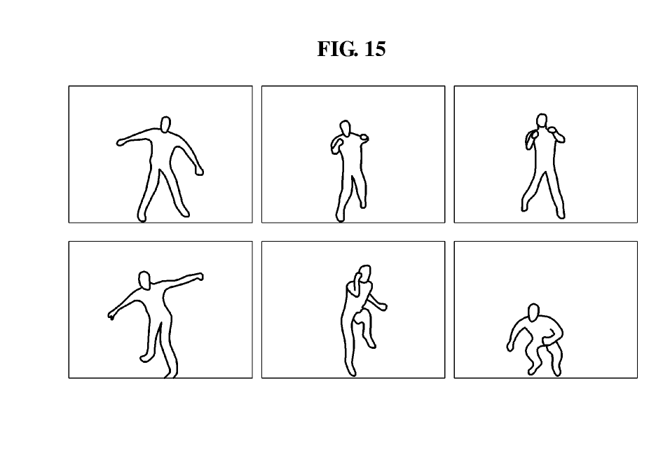

FIG. 15 illustrates an example of training data according to an embodiment. As an example, the training data includes images of various body postures. A recognizer training apparatus divides the images of the various body postures into data sets or clusters by performing clustering based on an unsupervised learning.

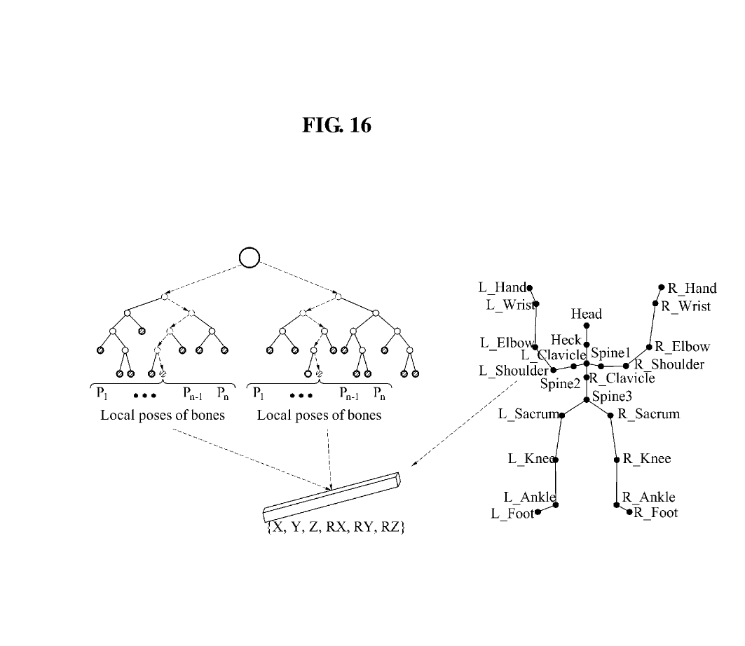

FIG. 16 illustrates an example of using information extracted from a leaf node of local sprigs according to an embodiment. For example, in a case of an image of a body posture, information on a three-dimensional location and direction of a frame is extracted from the leaf node of the local sprigs. A data recognizer estimates the body posture using the information on the three-dimensional location and direction of the frame extracted from the leaf node of the local sprigs.

The information stored in the leaf node of the local sprigs is converted to various forms and stored in the leaf node. For example, index information on an image number of a posture is stored in the leaf node of the local sprigs. In a case of 3D body volume information, the index information on a 3D volume number is stored in the leaf node of the local sprigs.

The apparatuses, units, modules, devices, and other components, for example, the recognizer training apparatus, training data selector, clustering unit, training data classifier, data recognizer, input data reader, cluster determiner, class determiner illustrated in FIGS. 1 through 4, that perform the operations described herein with respect to FIGS. 5-9, 12-14, and 16 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 5-9, 12-14, and 16. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 5-9, 12-14, and 16 that perform the operations described herein with respect to FIGS. 5-9, 12-14, and 16 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

1. A recognizer training method, the method comprising:
selecting training data;
generating clusters by clustering the selected training data based on a global shape parameter; and
classifying training data from at least one cluster based on a local shape feature.

2. The method of claim 1, wherein the global shape parameter is used to determine a global feature of the selected training data, and the local shape feature is used to determine a local feature of the training data from the cluster.

3. The method of claim 1, wherein the generating comprises:
determining a parameter value of the global shape parameter;
determining a parameter vector of the selected training data using the determined parameter value;
dividing the parameter vector into data sets;
verifying whether a degree of separation between the data sets satisfies a predetermined condition; and
storing division information on the generating of the clusters when the degree of separation satisfies the predetermined condition.

4. The method of claim 3, wherein the dividing of the parameter vector comprises:
dividing the parameter vector into the data sets based on randomly determined threshold values, and
wherein an arbitrary number of the threshold values are generated.

5. The method of claim 3, wherein the degree of separation is determined based on a mean and a standard deviation of each data set.

6. The method of claim 3, wherein the division information on the generating of the clusters comprises information on the global shape parameter used to generate the clusters and information on the threshold values used to divide the parameter vector into the data sets.

7. The method of claim 3, wherein, the degree of separation satisfies the predetermined condition when a currently determined degree of separation is greatest among degrees of separation determined based on global shape parameter.

8. The method of claim 1, wherein the classifying comprises:
determining a feature value of the local shape feature;
determining a feature vector of the training data from the cluster based on the determined feature value;
dividing the feature vector into data sets;
verifying whether an entropy determined based on the data sets satisfies a predetermined condition; and
storing division information on the classifying of the training data from the cluster when the entropy satisfies the predetermined condition.

9. The method of claim 8, wherein the dividing of the feature vector comprises:
dividing the feature vector into the data sets based on randomly determined threshold values; and
wherein an arbitrary number of the threshold values are generated.

10. The method of claim 8, wherein the division information on the classifying of the training data from the cluster comprises information on the local shape feature used to classify the training data from the cluster, and information on the threshold values used to divide the feature vector into the data sets.

11. The method of claim 8, wherein, when a currently determined entropy is smallest among entropies determined based on local shape features, the verifying comprises determining that the entropy satisfies the predetermined condition.

12. A data recognizing method, the method comprising:
reading input data;
determining a cluster to which the input data belongs based on learned global shape parameter information; and
determining a class of the input data based on the determined cluster and learned local shape feature information.

13. The method of claim 12, wherein the learned global shape parameter information is used to determine a global feature of the input data, and the learned local shape feature information is used to determine a local feature of the input data.

14. The method of claim 12, wherein the determining of the cluster comprises:
determining a parameter value of the input data based on the learned global shape parameter information; and
determining the cluster corresponding to the determined parameter value using information on a stored threshold value.

15. The method of claim 12, wherein the determining of the class comprises:
loading at least one recognizer to classify data from the determined cluster; and
estimating the class of the input data based on the recognizer and the local shape feature information.

16. The method of claim 15, wherein the estimating of the class comprises:
determining a feature value of the input data based on the local shape feature nformation; and
estimating the class of the input data based on the determined feature value and information on a threshold value stored in the recognizer.

17. A non-transitory computer-readable medium comprising instructions for a computer to perform the method of claim 1.

18. (canceled)

19. (canceled)

20. A data recognizer, comprising:
at least one processor; and
a memory having instructions stored thereon executed by the at least one processor to perform:
input data;
determining a cluster to which the input data belongs based on learned global shape parameter information; and
determining a class of the input data based on the determined cluster and learned local shape feature information.
